(19) United States
(12) Patent Application Publication
(10) Pub. No.: US 2012/0066628 A1
(43) Pub. Date: Mar. 15, 2012

(54) DRAG-ABLE TABS

(75) Inventors: Michael J. Ens, Redmond, WA (US); Louis A. Martinez, Redmond, WA (US); Mike Pell, Woodinville, WA (US); Eugene Chang, Redmond, WA (US)

(73) Assignee: MICROSOFT CORPORATION, Redmond, WA (US)

(21) Appl. No.: 12/878,745

(22) Filed: Sep. 9, 2010

(51) Int. Cl. G06F 3/048

(52) U.S. Cl. 715/769

(57) ABSTRACT

Various embodiments enable a tab within a web browser user interface to be dragged out of an associated tab band in which it appears. When dragged outside of the tab band, content can be rendered within a window associated with the tab. This permits side-by-side viewing of content in the primary web browser user interface as well as the window associated with the tab that has been dragged out of the tab band. In one or more embodiments, content that is associated with a dragged tab's window can include live content, such as multimedia presentations.

### BACKGROUND

In Web browsing scenarios, it is not easy to compare content in a side-by-side fashion in a single browser. Moreover, in the tabbed browsing context, tabs tend to remain within the context of the web browser with which they are associated. To access content within a particular tab, the user typically has to click on the tab to bring it into focus, thus losing focus with the content in the tab from which they navigated. The content associated with the new tab is then presented to the user within the browser interface.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments enable a tab within a web browser user interface to be dragged out of an associated tab band in which it appears. When dragged outside of the tab band, content can be rendered within a window associated with the tab. This permits side-by-side viewing of content in the primary web browser user interface as well as the window associated with the tab that has been dragged out of the tab band. In one or more embodiments, content that is associated with a dragged tab's window can include live content, such as multimedia presentations.

In one or more embodiments, a drag-able tab's window can be docked to the sides of the display screen and/or the top or bottom of the display screen. The docking behavior of a drag-able tab's window can change depending on where the window is docked.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 illustrates an example web browser user interface in accordance with one or more embodiments.

FIG. 3 shows an example tab after it has been dragged from a tab band into a content rendering area of a web browser user interface, in accordance with one or more embodiments.

FIG. 4 illustrates the state of a tab after it has been “dropped” onto the desktop, in accordance with one or more embodiments.

FIG. 5 illustrates an example snapping operation in accordance with one or more embodiments.

FIG. 6 illustrates tab-dragging between different browser instances in accordance with one or more embodiments.

FIG. 7 illustrates tab-dragging between different browser instances in accordance with one or more embodiments.

FIG. 8 is a flow diagram that describes steps in a method in accordance with one or more embodiments.

FIG. 9 is a flow diagram that describes steps in a method in accordance with one or more embodiments.

FIG. 10 illustrates an example system that can be used to implement one or more embodiments.

### DETAILED DESCRIPTION

Overview

Various embodiments enable a tab within a web browser user interface to be dragged out of an associated tab band in which it appears. When dragged outside of the tab band, content can be rendered within a window associated with the tab. This permits side-by-side viewing of content in the primary web browser user interface as well as the window associated with the tab that has been dragged out of the tab band. In one or more embodiments, content that is associated with a dragged tab's window can include live content, such as multimedia presentations.

In one or more embodiments, a drag-able tab's window can be docked to the sides of the display screen and/or the top or bottom of the display screen. The docking behavior of a drag-able tab's window can change depending on where the window is docked.

In the discussion that follows, a section entitled “Operating Environment” is provided and describes one environment in which one or more embodiments can be employed. Following this, a section entitled “Example Drag-able Tab” describes an example tab that can be dragged in accordance with one or more embodiments. Next, a section entitled “Example Snap-able Tab” describes how a tab can be snapped to a display screen side in accordance with one or more embodiments. Following this, a section entitled “Tab-dragging Between Different Browser Instances” describes how tabs can be dragged between different browser instances in accordance with one or more embodiments. Next, a section entitled “Pinning a Tab to the Desktop Task Bar” describes how a tab can be pinned to a desktop taskbar in accordance with one or more embodiments. Following this, a section entitled “Example Methods” describes example methods in accordance with one or more embodiments. Last, a section entitled “Example System” describes an example system that can be utilized to implement one or more embodiments.

Operating Environment

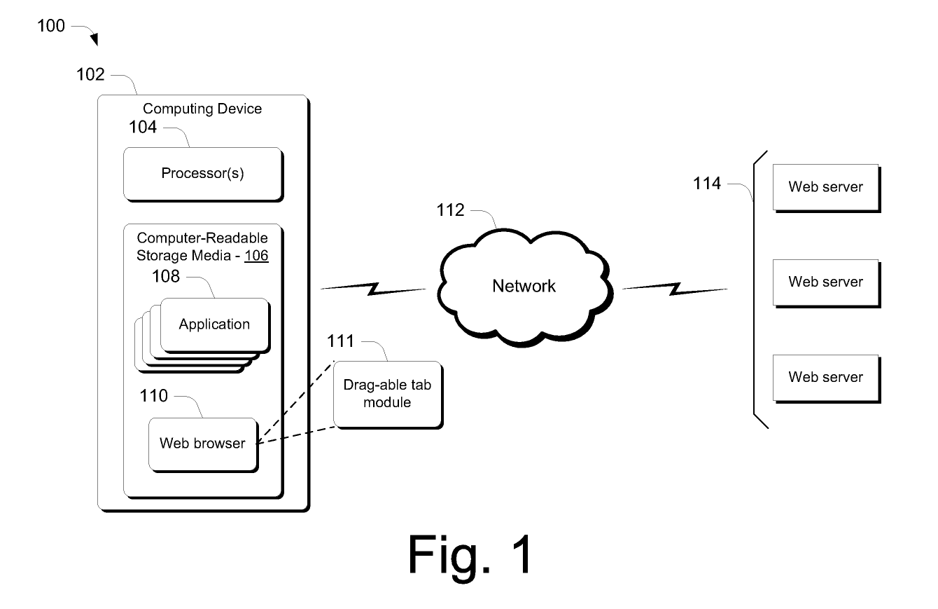

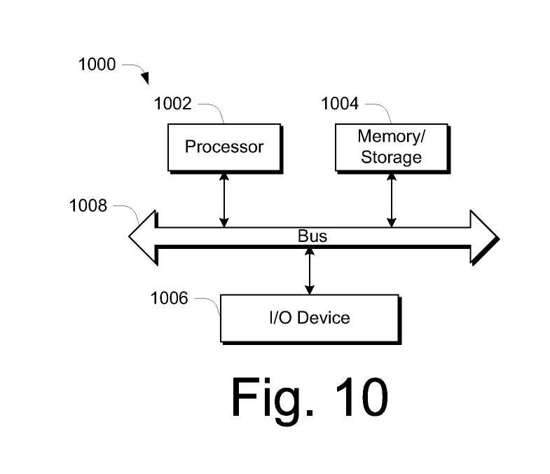

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). The computer-readable storage media can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 10.

In addition, computing device 102 includes a software application in the form of a web browser 110 that includes or otherwise makes use of a drag-able tab module 111 that operates as described above and below. In one or more embodiments, the drag-able tab module enables a tab within a web browser user interface to be dragged out of an associated tab band in which it appears. When dragged outside of the tab band, content can be rendered within a window associated with the tab. This permits side-by-side viewing of content in the primary web browser user interface, as well as the window associated with the tab that has been dragged out of the tab band. In one or more embodiments, content that is associated with a dragged tab's window can include live content, such as multimedia presentations. In one or more embodiments, a drag-able tab's window can be docked to the sides of the display screen and/or the top or bottom of the display screen. The docking behavior of a drag-able tab's window can change depending on where the window is docked, as will become apparent below.

In addition, environment 100 includes a network 112, such as the Internet, and one or more web servers 114 from and to which content can be received and sent, as described above and below. Such content can include web pages that are received from the web servers.

Computing device 102 can be embodied as any suitable computing device such as, by way of example and not limitation, a desktop computer, a portable computer, a handheld computer such as a personal digital assistant (PDA), cell phone, and the like.

Having described an example operating environment, consider now a discussion of some example embodiments that can utilize drag-able tab module 111.

Example Drag-Able Tab

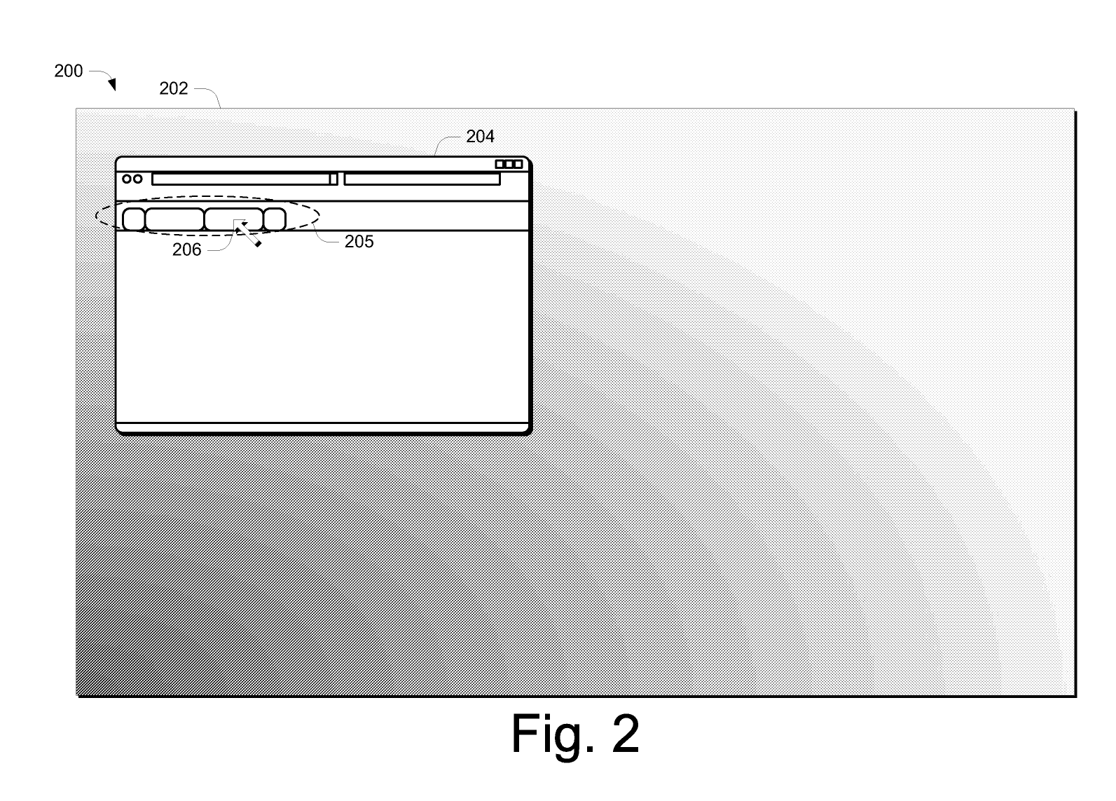

FIG. 2 illustrates an example system, in accordance with one or more embodiments, generally at 200. System 200 includes a display screen 202 that forms part of or otherwise presents a client computer's desktop. Within display screen 202, a web browser user interface 204 is shown. The web browser associated with the web browser user interface can include functionality that is typically associated with a web browser including, by way of example and not limitation, functionality that permits an individual to navigate between and amongst multiple websites. In this particular example, the web browser associated with web browser user interface 204 allows for tabbed browsing by enabling a plurality of tabs to be used to load content of individual pages. The tabs appear in a tab band 205 that extends across the web browser user interface. An individual tab appearing within the tab band is shown at 206 and is the subject of the discussion below.

In the illustrated and described embodiment, a tab can be dragged from the tab band and have an associated window rendered to include content associated with the tab. Any suitable type of input can be provided to drag the tab from the tab band. For example, on touch-sensitive devices, a user may, for example, touch a tab with their finger or a pen and drag the tab from the tab band as described below. Alternately or additionally, a user may drag a tab from the tab band using a drag and a drop operation with, for example, a mouse. As an example, notice in FIG. 2 that a cursor has been placed over tab 206. By left-clicking on the tab, the user can now drag the tab from the tab band as described below.

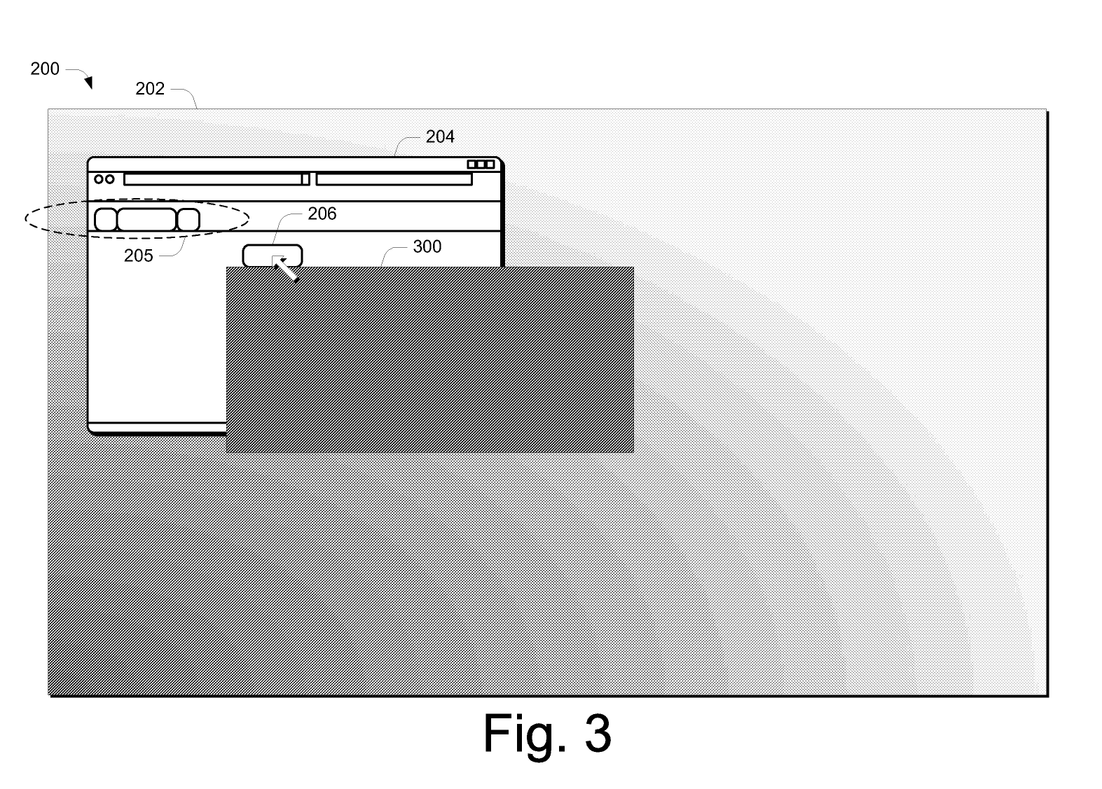

FIG. 3 shows tab 206 after it has been dragged from the tab band 205 into a content rendering area of the web browser user interface 204. Responsive to being dragged from the tab band, a window 300 is created to host content associated with tab 206. In this example, the tab is rendered adjacent window 300 and forms a contiguous, visual unit. As noted above, the tabbed content can include live content that is rendered in real time. Here, rendered content in window 300 is represented by the grey color within window 300. As the tab is dragged, the position of the mouse (or other input device or mechanism) is monitored so that the window 300 can be moved along with tab 206.

From this location, tab 206 can be dragged within the confines of the web browser user interface 204 or outside of the confines of the web browser user interface, such as onto the client computing device's desktop.

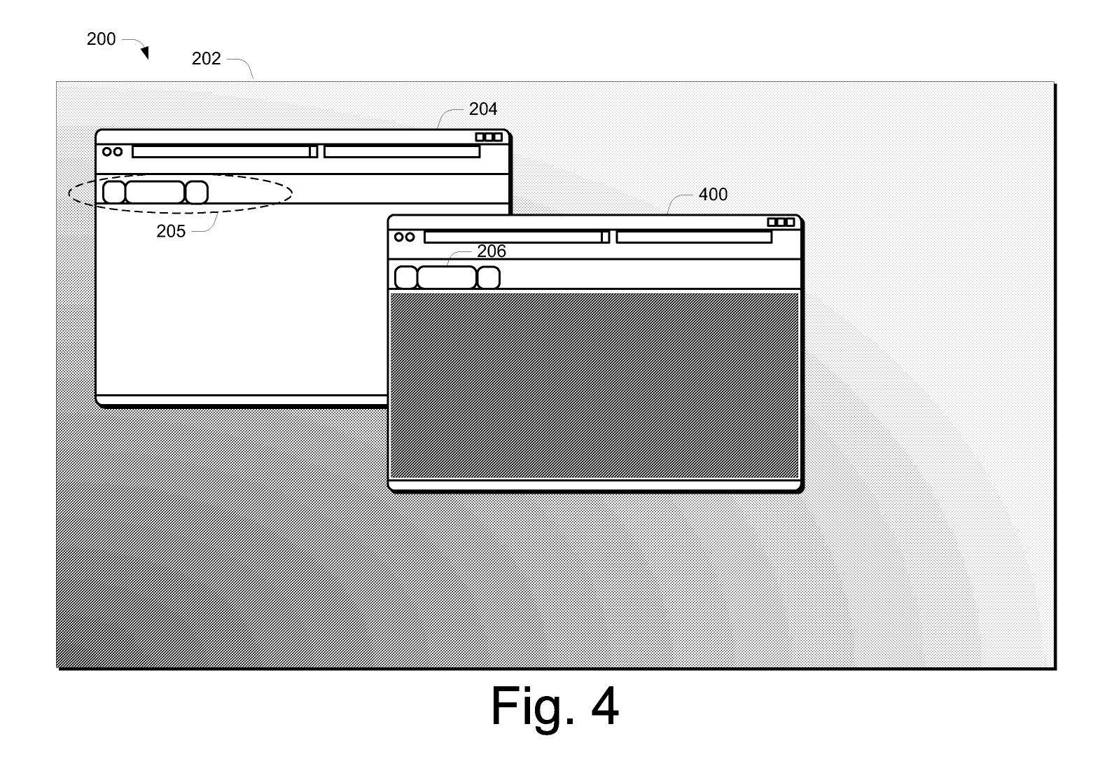

FIG. 4 illustrates the state of tab 206 after a user has released the mouse button or “dropped” the tab to complete or terminate the drag operation. In one or more embodiments, when this occurs, a new browser instance of the same browser is instantiated and the tabbed content is rendered therewithin. As an example, FIG. 4 illustrates a new web browser user interface 400 in which the tabbed content associated with tab 206 has been rendered. This can permit side-by-side comparison of content within web browser user interface 204 and web browser user interface 400.

Example Snap-Able Tab

In one or more embodiments, a drag-able tab's window can be docked to the sides of the display screen and/or the top or bottom of the display screen. The docking behavior of a drag-able tab's window can change depending on where the window is docked.

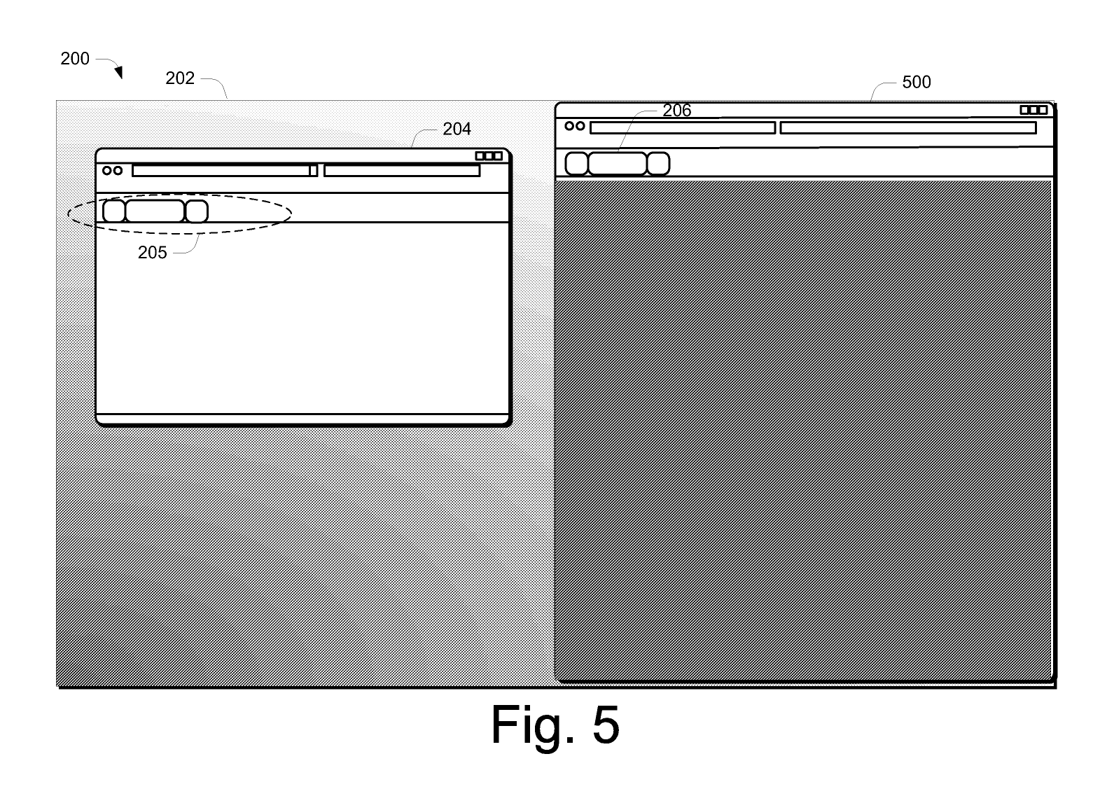

As an example, consider again FIG. 3 in which tab 206 is dragged out of the tab band and, responsively, a window 300 is created in which the content of the tab is rendered. Assume in this example, that tab 206 and window 300 are dragged onto the desktop and toward the right side of the display screen. At some distance threshold relative to the right side of the display screen, the tab 206 and window 300 can be “snapped” or docked, as shown in FIG. 5, to the right side of the display screen. In this example, snapping includes rendering a new instance of the web browser to occupy 50% of the display screen's real estate. In addition, the content of the tab is rendered within a new web browser user interface 500. Any suitable distance threshold can be utilized in the snapping operation. For example, a distance threshold can be defined as a proximity of one or more pixels.

In one or more embodiments, the docking behavior of the tab can vary depending on where it is to be docked. In this particular example, docking to the left or right side of the display screen results in the rendering of a web browser user interface that occupies 50% of the display screen's real estate. Docking to the top or bottom of the display screen results in the rendering of a web browser user interface that occupies 100% of the display screen. Any suitable behavior can be employed without departing from the spirit and scope of the claimed subject matter. For example, web browser user interfaces can be rendered to be any suitably size less than or greater than 50 of the display screen's real estate.

Tab-Dragging Between Different Browser Instances

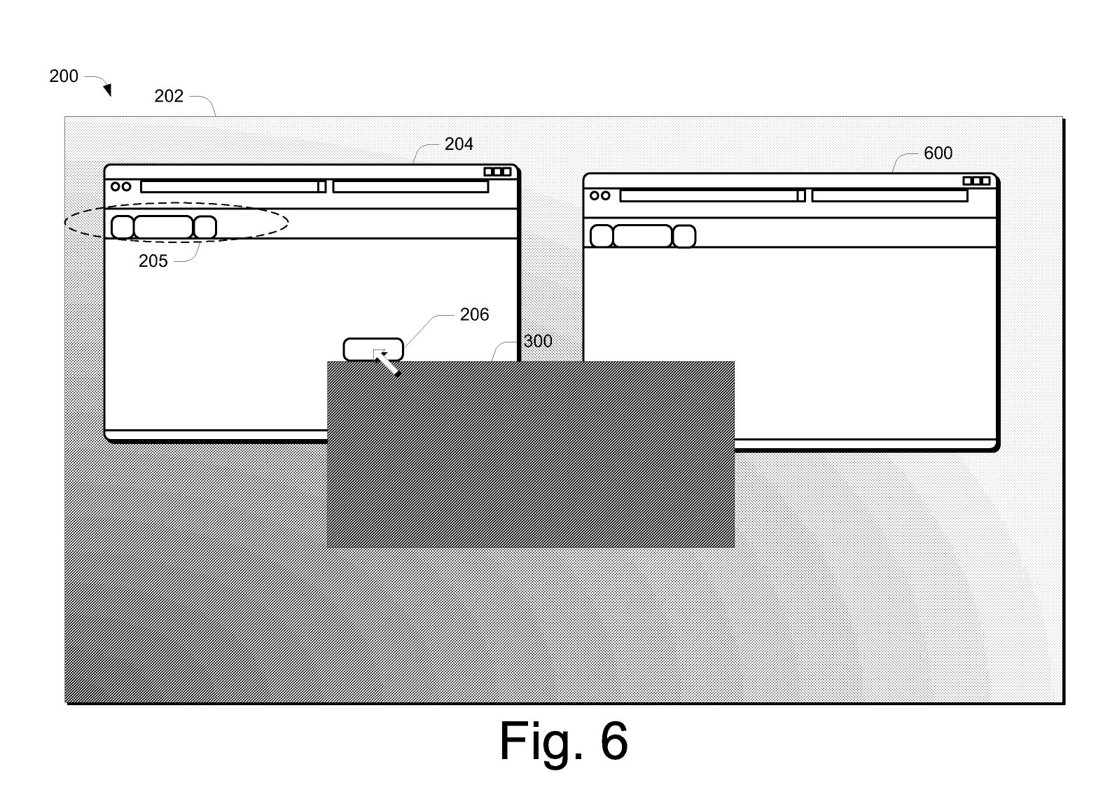

In one or more embodiments, a tab can be dragged between different instances of the same web browser. As an example, consider FIG. 6.

There, different instances of the same web browser have respective web browser user interfaces 204, 600. In this example, tab 206 is dragged out of the tab band 205 associated with web browser user interface 204. As a result, the window 300 as described above is rendered to include the tab's content. Assume now, in this example, the user continues to drag 206 towards web browser user interface 600. During this dragging operation, the position of the mouse is monitored relative to positions of other content that is rendered on the display screen, e.g. the web browser user interface 600.

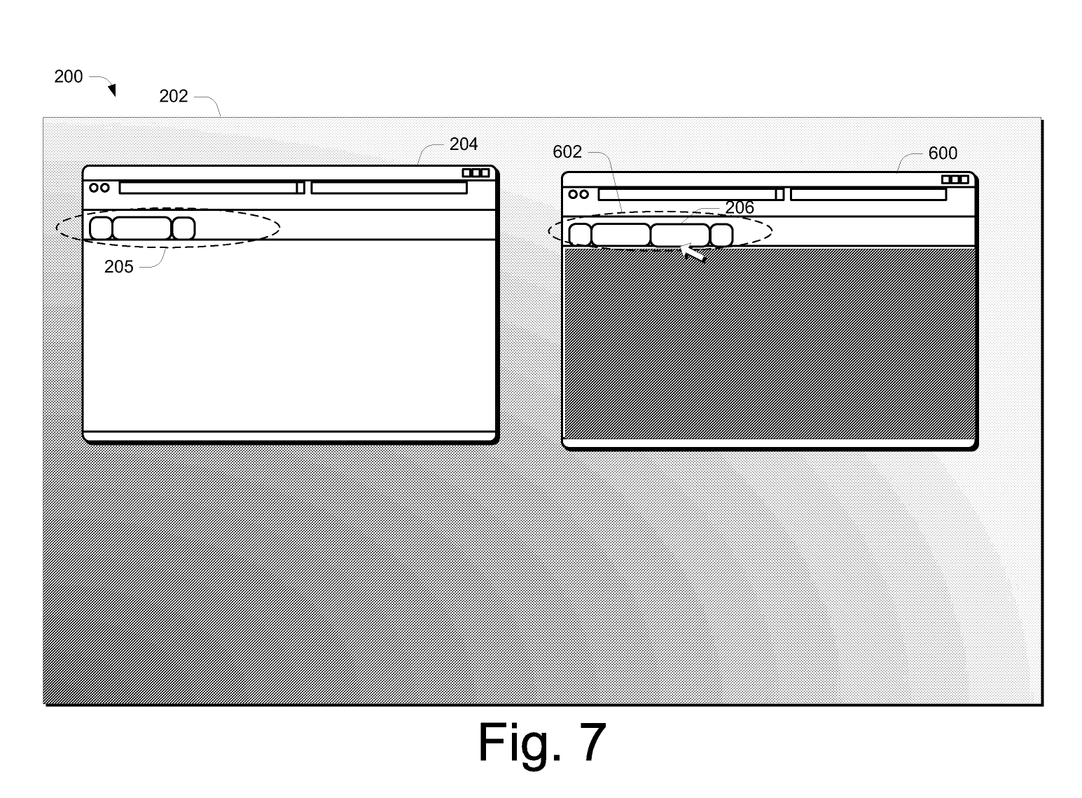

FIG. 7 illustrates the state of web browser user interface 600 after the tab has been dragged onto tab band 602. In one or more embodiments, a threshold distance can be defined, relative to tab band 602, such that when the curser crosses the threshold, tab 206 is inserted into the tab band 602 and a message is sent to the tab band 602 to enable the dragged tab's content to be rendered in the content rendering area of web browser user interface 600, as shown in FIG. 7. At this point, the user can release the left mouse button or continue to drag the tab elsewhere. Note that in the implementation just described, the tab 206 is inserted into the tab band 602 and the content of the dragged tab is rendered in the web browser user interface 600 without the user having the release the left mouse button. Other approaches can, however, be used without departing from the spirit and scope of the claimed subject matter.

Pinning a Tab to the Desktop Task Bar

In one or more embodiments, a tab can be pinned to a desktop's taskbar that appears at the bottom of the display screen. To pin a tab, the tab is dragged from the tab band as described above and onto or over the desktop's taskbar. Releasing the tab results in the tab being pinned to the taskbar.

In operation, in at least one embodiment, as the tab is moved over the task bar, a file is created, in advance of pinning, and includes a start URL, an icon such as a favicon, and other metadata. Content of the file is received from the website associated with the tab's content. Content of the file enables the website associated with the now-pinned tab to be launched directly from the taskbar when the icon is selected. This creates, in at least some embodiments, a so-called site mode browser in which content of the tab can be rendered. A site mode browser can be thought of as a pared down web browser in which the owner of the pinned tab's content can define the user experience through the file that is created in advance of the tab being pinned.

Having considered various embodiments described above, consider now some example methods in accordance with one or more embodiments.

Example Methods

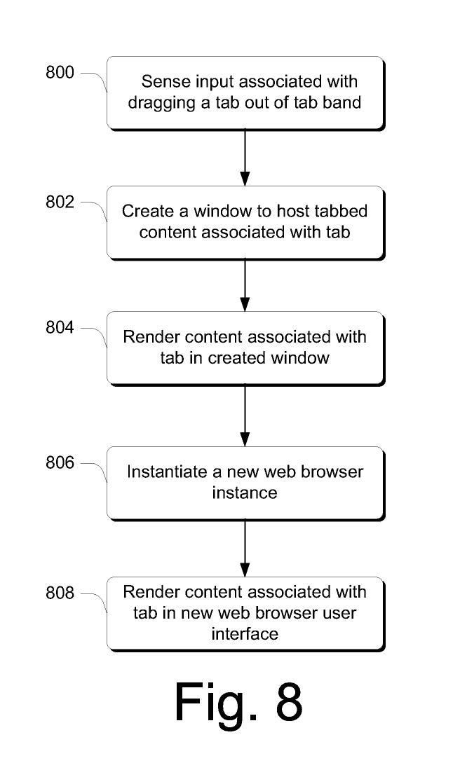

FIG. 8 is a flow diagram that describes steps a method in accordance with one or more embodiments. The method can be implemented in connection with any suitable hardware, software, firmware, or combination thereof. In at least some embodiments, the method can be implemented in software in the form of a drag-able tab module, such as the one described above.

Step 800 senses input associated with dragging a tab out of a tab band associated with a web browser user interface. Any suitable type of input can be sensed, examples of which are provided above. Step 802 creates a window to host tabbed content associated with the tab. The step can be performed in any suitable way. For example, the input associated with dragging the tab can be tracked and, once a threshold relative to the tab band is crossed, a window can be created relative to the tab being dragged. Step 804 renders content associated with the tab in the created window. This can include any suitable type of content including live multimedia content such that as the tab is dragged around, the live multimedia content can continue to be rendered.

Step 806 instantiates a new web browser instance. The step can be performed in any suitable way. For example, upon termination of the drag operation that resulted in the tab being dragged from the tab band, a new web browser instance can be instantiated. Termination of the drag operation can occur in any suitable way such as, releasing a left mouse button that was used to initiate the drag operation, lifting a finger from a touch-sensitive screen, lifting a pen from a touch-sensitive screen, and the like.

Step 808 renders content associated with the tab in a new web browser user interface associated with the new web browser instance.

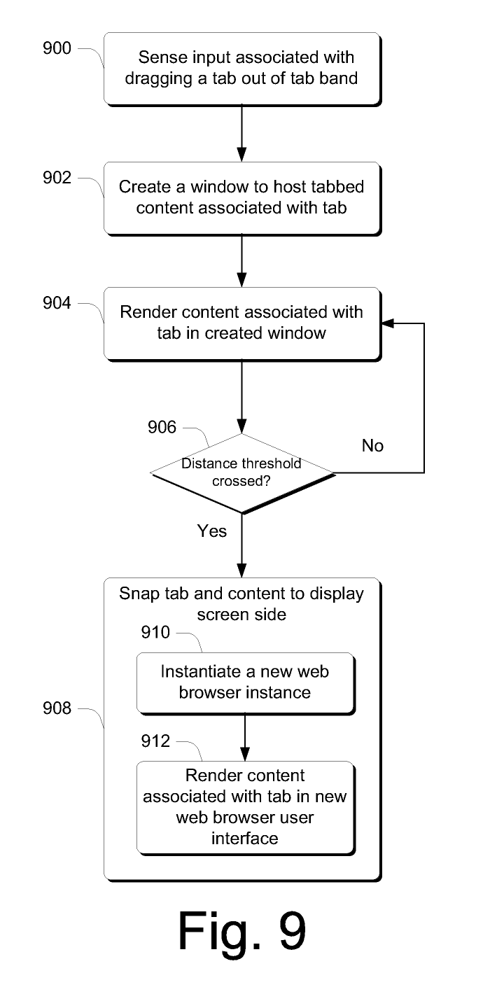

FIG. 9 is a flow diagram that describes steps a method in accordance with one or more embodiments. The method can be implemented in connection with any suitable hardware, software, firmware, or combination thereof. In at least some embodiments, the method can be implemented in software in the form of a drag-able tab module, such as the one described above.

Step 900 senses input associated with dragging a tab out of a tab band associated with a web browser user interface. Any suitable type of input can be sensed, examples of which are provided above. Step 902 creates a window to host tabbed content associated with the tab. The step can be performed in any suitable way. For example, the input associated with dragging the tab can be tracked and, once a threshold relative to the tab band is crossed, a window can be created relative to the tab being dragged. Step 904 renders content associated with the tab in the created window. This can include any suitable type of content including live multimedia content such that as the tab is dragged around, the live multimedia content can continue to be rendered.

Step 906 ascertains whether a distance threshold relative to a display screen side has been crossed. If the distance threshold has not been crossed, the method returns to step 904. If, on the other hand, the distance threshold has been crossed, step 908 snaps the tab and its associated content to the display screen side. Such can be performed in any suitable way. For example, step 910 can instantiate a new web browser instance and step 912 can render content associated with the tab in a new web browser user interface associated with the new web browser instance. In one implementation, this operation is performed in a manner such that other system components, including but not limited to the web browser, treat the new browser instance the same as a Window that was docked via a titlebar drag, as will be appreciated by the skilled artisan.

Having described example methods that can be utilized in accordance with one more embodiments, consider now an example system that can be utilized to implement one or more embodiments.

Example System

FIG. 10 illustrates an example computing device 1000 that can be used to implement the various embodiments described above. Computing device 1000 can be, for example, computing device 102 or Web server 114 of FIG. 1.

Computing device 1000 includes one or more processors or processing units 1002, one or more memory and/or storage components 1004, one or more input/output (I/O) devices 1006, and a bus 1008 that allows the various components and devices to communicate with one another. Bus 1008 represents one or more of any of several types of bus structures, including a memory bus or memory controller, a peripheral bus, an accelerated graphics port, and a processor or local bus using any of a variety of bus architectures. Bus 1008 can include wired and/or wireless buses.

Memory/storage component 1004 represents one or more computer storage media. Component 1004 can include volatile media (such as random access memory (RAM)) and/or nonvolatile media (such as read only memory (ROM), Flash memory, optical disks, magnetic disks, and so forth). Component 1004 can include fixed media (e.g., RAM, ROM, a fixed hard drive, etc.) as well as removable media (e.g., a Flash memory drive, a removable hard drive, an optical disk, and so forth).

One or more input/output devices 1006 allow a user to enter commands and information to computing device 1000, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer-readable storage media”.

“Computer-readable storage media” include volatile and non-volatile, removable and non-removable media implemented in any method or technology for storage of information such as computer readable instructions, data structures, program modules, or other data. Computer-readable storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments enable a tab within a web browser user interface to be dragged out of an associated tab band in which it appears. When dragged outside of the tab band, content can be rendered within a window associated with the tab. This permits side-by-side viewing of content in the primary web browser user interface as well as the window associated with the tab that has been dragged out of the tab band. In one or more embodiments, content that is associated with a dragged tab's window can include live content, such as multimedia presentations.

In one or more embodiments, a drag-able tab's window can be docked to the sides of the display screen and/or the top or bottom of the display screen. The docking behavior of a drag-able tab's window can change depending on where the window is docked.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method comprising:
sensing input associated with dragging a tab out of a tab band associated with a web browser user interface;
responsive to said sensing, creating a window to host tabbed content associated with the tab; and
rendering content associated with the tab in said window.

2. The computer-implemented method of claim 1, wherein said sensing input comprises sensing a mouse click.

3. The computer-implemented method of claim 1, wherein said rendering content comprises rendering multimedia content.

4. The computer-implemented method of claim 1 further comprising:
instantiating a new web browser instance; and
rendering content associated with the tab in a new web browser user interface associated with the new web browser instance.

5. The computer-implemented method of claim 1 further comprising:
instantiating a new web browser instance; and
rendering content associated with the tab in a new web browser user interface associated with the new web browser instance.
wherein said instantiating is performed responsive to termination of a drag operation that resulted in the tab being dragged from the tab band.

6. The computer-implemented method of claim 1 further comprising:
instantiating a new web browser instance;
rendering content associated with the tab in a new web browser user interface associated with the new web browser instance; and
wherein said instantiating is performed responsive to termination of a drag operation that resulted in the tab being dragged from the tab band; and
wherein termination of the drag operation occurs responsive to sensing release of a left mouse button.

7. A computer-implemented method comprising:
sensing input associated with dragging a tab out of a tab band associated with a web browser user interface;
responsive to said sensing, creating a window to host tabbed content associated with the tab;
rendering content associated with the tab in said window; and
snapping the tab and its associated content to a display screen side.

8. The computer-implemented method of claim 7, wherein said snapping comprises:
ascertaining whether a distance threshold relative to the display screen side has been crossed; and
responsive to said distance threshold being crossed, performing said snapping.

9. The computer-implemented method of claim 7, wherein said snapping comprises:
instantiating a new web browser user interface; and
rendering content associated with the tab in the new web browser user interface.

10. The computer-implemented method of claim 7, wherein said sensing input comprises sensing a mouse click.

11. The computer-implemented method of claim 7, wherein said rendering content comprises rendering multimedia content.

12. One or more computer readable storage media embodying computer readable instructions which, when executed, are configured to:
sense a mouse input associated with dragging a tab out of a tab band associated with a web browser user interface;
responsive to sensing the mouse input, create a window to host tabbed content associated with the tab; and
render content associated with the tab in said window.

13. The one or more computer readable storage media of claim 12, wherein the instructions are further configured to:
instantiate a new web browser instance; and
render content associated with the tab in a new web browser user interface associated with the new web browser instance.

14. The one or more computer readable storage media of claim 12, wherein the instructions are further configured to:
instantiate a new web browser instance;
render content associated with the tab in a new web browser user interface associated with the new web browser instance, and
wherein the instructions are further configured to instantiate the new web browser instance responsive to termination of a drag operation that resulted in the tab being dragged from the tab band.

15. The one or more computer readable storage media of claim 12, wherein the instructions are further configured to snap the tab and its associated content to a display screen side.

16. The one or more computer readable storage media of claim 12, wherein the instructions are further configured to snap the tab and its associated content to a display screen side by rendering a web browser user interface, including the associated content, that occupies about 50% of the display screen's real estate.

17. The one or more computer readable storage media of claim 12, wherein the instructions are further configured to snap the tab and its associated content to a display screen side by rendering a web browser user interface, including the associated content, that occupies more than about 50% of the display screen's real estate.

18. The one or more computer readable storage media of claim 12, wherein the instructions are further configured to enable a tab to be dragged between different instances of a same web browser.

19. The one or more computer readable storage media of claim 12, wherein the instructions are further configured to:
enable a tab to be dragged between different instances of a same web browser,
enable the tab that is dragged between the different instances of the web browser to be dropped onto a tab band that is different from a tab band from which the tab was dragged.

20. The one or more computer readable storage media of claim 12, wherein the instructions are further configured to enable a tab to be pinned to a desktop's taskbar.
